(19) United States
(12) Patent Application Publication
(10) Pub. No.: US 2025/0338893 A1
(43) Pub. Date: Nov. 6, 2025

(54) AEROSOL-GENERATING DEVICE FOR GENERATING AN AEROSOL BY MICROWAVE HEATING OF AN AEROSOL-FORMING SUBSTRATE

(71) Applicant: Philip Morris Products S.A., Neuchatel (CH)

(72) Inventors: Arsen HAKHOUMIAN, Yerevan (AM); Hovhannes HAROYAN, Yerevan (AM); Hrayr HOVSEPYAN, Yerevan (AM)

(73) Assignee: Philip Morris Products S.A., Neuchatel (CH)

(21) Appl. No.: 18/854,388

(22) PCT Filed: Apr. 17, 2023
(86) PCT No.: PCT/EP2023/059871

§ 371 Date: Oct. 4, 2024

(30) Foreign Application Priority Data
Apr. 21, 2022 (AM) AM20220042

(51) Int. Cl. A24F 40/46; H05B 6/64; H05B 6/76; H05B 6/80

(52) U.S. Cl. CPC A24F 40/46; H05B 6/6402; H05B 6/76; H05B 6/802; H05B 2206/04

(57) ABSTRACT

An aerosol-generating device for generating an aerosol by microwave heating of an aerosol-forming substrate contained in a substrate portion of a cylindrical aerosol-generating article is provided, the aerosol-generating device including: a microwave generator configured to generate a microwave signal; a cylindrical microwave cavity configured to removably receive at least the substrate portion of the cylindrical aerosol-generating article; and a coaxial feed exciter operatively connected to the microwave generator and coupled to the cylindrical microwave cavity such as to feed the microwave signal into the cylindrical microwave cavity and excite at least one specific transverse magnetic mode or transverse electric mode within the cylindrical microwave cavity when the substrate portion of the cylindrical aerosol-generating article is received in the cylindrical microwave cavity. An aerosol-generating system including the aerosol-generating device and a cylindrical aerosol-generating article including a distal substrate portion containing an aerosol-forming substrate is also provided.

The present disclosure relates to an aerosol-generating device for generating an inhalable aerosol by microwave heating of an aerosol-forming substrate, in particular an aerosol-forming substrate that is contained in an aerosol-generating article the device is configured for use with. The invention further relates to an aerosol-generating system comprising such a device and such an article.

In general, microwave heating of aerosol-forming substrates is based on the principles of dielectric heating which occurs when a high-frequency electromagnetic radiation stimulates the oscillation of dipolar molecules within the substrate, such as water molecules in the surrounding medium, at very high speed. These high-speed vibrations cause friction between the stimulated dipolar molecules that in turn generates heat within the substrate.

Aerosol-generating devices for generating inhalable heating aerosols by microwave heating of aerosol-forming substrates are generally known from prior art. As an example, such devices may comprise a microwave generating unit, a cavity for receiving an aerosol-generating article containing the aerosol-forming substrate to be heated, and a microwave antenna located outside the cavity that is configured to transmit the microwaves generated by the microwave generating unit to a predetermined effective area range in the cavity in order to heat the substrate. While this configuration has proven to be capable of sufficient aerosol generation, even if implemented in a portable aerosol-generating device, there is still an ongoing demand to make the microwave heating process of the aerosol-forming substrate more efficient and homogeneous.

Therefore, it would be desirable to have an aerosol-generating device for use with an aerosol-generating article and a corresponding aerosol-generating system employing microwave heating which offer the advantages of prior art solutions, whilst mitigating their limitations. In particular, it would be desirable to have an aerosol-generating device and a corresponding system providing enhanced microwave heating of the aerosol-forming substrate within the article when it is received in the device.

According to the invention there is provided an aerosol-generating device for generating an aerosol by microwave heating of an aerosol-forming substrate that is contained in a substrate portion of a cylindrical aerosol-generating article. The aerosol-generating device comprises a microwave generator configured to generate a microwave signal as well as a cylindrical microwave cavity configured to removably receive at least the substrate portion of the aerosol-generating article. Furthermore, the aerosol-generating device comprises a coaxial feed exciter operatively connected to the microwave generator and coupled to the microwave cavity such as to feed the microwave signal into the microwave cavity and excite at least one specific transverse magnetic mode or transverse electric mode within the microwave cavity when the substrate portion of the article is received in the microwave cavity.

Preferably, the microwave cavity has at least one closed axial end, in particular only one closed axial end, in particular a distal closed end. Likewise, the microwave cavity preferably has at least one open axial end, in particular only one open axial end, in particular a proximal open end. In principle, it is also possible that the microwave cavity has two open axial ends, such as a distal open end and a proximal open end.

According to the invention, it has been found that microwave heating of an aerosol-forming substrate can be enhanced with regard to both, efficiency and homogeneity, by implementing a microwave heating hollow resonator based on a waveguide structure that supports microwave propagation along the axial direction of the cylindrical microwave cavity, in particular that supports the propagation of microwave modes having a homogeneous field distribution. Such a waveguide structure may be provided when the inner surface of the cylindrical microwave cavity, in particular when at least the inner surface along the inner circumference of the microwave cavity, is reflective for microwaves, for example, when it is electrically conductive. Alternatively, a similar waveguide structure may be provided by the article when it has a reflective shell in the substrate portion, for example, a metallic wrapper circumferentially surrounding the aerosol-forming substrate.

Furthermore, it has been found that in such a waveguide structure a hollow resonator configuration can be easily realized when the substrate portion of the aerosol-generating article, that is to be received in the cylindrical microwave cavity, has a higher dielectric permeability than other portions of the article along a length axis of the cylindrical aerosol-generating article, for example, more proximal portions of the article, such that along a length axis of the waveguide structure the dielectric permeability of the medium within the microwave cavity abruptly changes at one or both axial end(s) of the substrate portion, for example, at a proximal end of the substrate portion. Typically, this change may result from a higher air content of the other portions of the article, such as in a filter portion. Depending on the frequency and the dimensions of the waveguide structure, the change of the dielectric permeability may thus prevent microwaves propagating through the substrate portion during use from further propagating beyond the axial end(s) of the substrate portion (exponentially decaying evanescent wave). Instead, the microwaves are reflected back into the opposite direction. Details of this effect will be described in more detail further below. This effect may be present in particular at a proximal end of the substrate portion adjacent to which more proximal portions of the article, such as a filter element, may be arranged. The same reflection effect may be present at the distal end of the substrate portion. There, a similar change of the dielectric permeability, such as down to the dielectric permeability of air, may occur when, for example, the distal end of the substrate portion forms the distal end of the article. This holds in particular, if the distal end of the substrate faces an air volume in the distal direction, for example, if there is a small air pocket between a possibly closed distal end of the microwave cavity and the distal end of the article received in the microwave cavity. Alternatively or in addition, the inner surface of the microwave cavity at at least one closed axial end, in particular a closed distal end of the microwave cavity may be reflective, in particular electrically conductive, in order to provide a reflection of the microwaves back into the opposite direction, in particular the proximal direction. As a result, microwaves, which are fed into the substrate portion when the article is received in the microwave cavity, may undergo reflection at both ends of the substrate portion which effectively corresponds to a resonator configuration.

Likewise, in an empty microwave cavity (with no article received therein, only filled with air) the low dielectric permeability of air may also prevent wave propagation through the empty wave guide structure, when the frequency of the microwave signal is properly chosen with respect to the dimensions of the cavity. Thus, leakage of the microwave field from a possibly open axial end of the microwave cavity, such as a proximal open end of the microwave cavity, may also be sufficiently suppressed.

As stated above, the specific spatial distribution of the microwave field within the substrate portion is important for a homogenous heating. For this, a proper a geometry match between the microwave cavity and the substrate portion is essential to ensure a close interaction of the aerosol-forming substrate with the microwave field that builds up in the microwave cavity in operation of the device. Accordingly, the inner cross-sectional shape of the cylindrical microwave cavity preferably matches the outer cross-sectional shape of the cylindrical aerosol-generating article, in particular of the substrate portion.

Preferably, the cylindrical microwave cavity is a circular-cylindrical microwave cavity. That is, the inner cross-sectional shape of the microwave cavity preferably is circular. This is particularly advantageous to match the outer shape of aerosol-generating articles having circular cylindrical outer shape, such as aerosol-generating articles resembling conventional cigarettes. Accordingly, the waveguide structure, that can be provided by a circular-cylindrical microwave cavity, is a circular waveguide structure.

Alternatively, the inner cross-sectional shape of the microwave cavity may be rectangular, in particular quadratic. That is, the cylindrical microwave cavity is a rectangular-cylindrical, in particular quadratic-cylindrical microwave cavity. The waveguide structure that can be provided by a rectangular-cylindrical, in particular a quadratic-cylindrical microwave cavity, is a rectangular, in particular quadratic waveguide structure.

In addition to the inner cross-sectional shape of the microwave cavity, the spatial distribution of the microwave field within the substrate portion may also be influenced by a proper choice of the shape and position of the coaxial feed exciter which determines the mode spectrum building up in the cavity in operation of the device. This is exploited in the present invention, by configuring the coaxial feed exciter and coupling it to the microwave cavity in such a way that the microwave signal provided by the microwave generator is fed into the microwave cavity in order to excite at least one specific transverse magnetic mode or transverse electric mode within the microwave cavity when the substrate portion of the article is received in the microwave cavity.

By definition, a transverse mode of electromagnetic radiation is a particular electromagnetic field pattern of the radiation in the plane perpendicular (i.e., transverse) to the propagation direction of the radiation. Transverse modes occur in microwaves that are confined to a waveguide structure, such as the waveguide structure of the present invention which can be realized—as described above—either by an electrically conductive inner surface of the microwave cavity itself or by a reflective shell of the article in the substrate portion, for example, by a metallic wrapper surrounding the aerosol-forming substrate. More particularly, transverse modes occur because of boundary conditions imposed on the microwave field by the waveguide structure. For example, in a cylindrical microwave guide as in the present invention, the tangential electric field amplitude of the microwaves must be zero at the walls of the waveguide structure, resulting in the transverse pattern of the electric field being restricted to those that fit between the walls of the waveguide structure. For this reason, the modes supported by a waveguide are quantized. The allowed modes can be found by solving Maxwell's equations for the boundary conditions of a given waveguide structure.

In circular or rectangular waveguide structures, there are only two kinds of transverse modes: Transverse magnetic modes (TM modes) and transverse electric modes (TE modes). Transverse magnetic modes (TM modes)—also called E waves—are characterized by the fact that the magnetic vector (H vector) is always perpendicular (transverse) to the direction of propagation while the electric field is normal to the direction of propagation. That is, a transverse magnetic mode has no magnetic field in the direction of propagation. Likewise, transverse electric modes (TE modes)—also called H waves—are characterized by the fact that the electric vector (E vector) being always perpendicular (transverse) to the direction of propagation while the magnetic field is normal to the direction of propagation. That is, a transverse electric mode has no electric field in the direction of propagation.

As mentioned above, the modes supported by a waveguide are quantized. Accordingly, the transverse magnetic and electric modes TMₘₙ and TEₘₙ in a circular or rectangular waveguide structure are described with indexes m and n, which stand for the field variation in radial and axial directions, respectively.

Waveguides only carry or propagate signals above a certain frequency, known as the cutoff frequency. The cutoff frequency of an electromagnetic waveguide is the lowest frequency for which a mode will propagate in it. Below the cutoff frequency, the waveguide structure is not able to carry the signals. The cutoff frequency is unique for a particular waveguide mode that is supposed to be propagating in a waveguide of a given cross-section and determines the lower frequency of the waveguide operating frequency range.

Solving Maxwell's equations for the boundary conditions of a circular waveguide results in the following formula for the cutoff frequency of a waveguide having a circular inner cross-sectional shape:

$${f}_{c , m n} = \frac{v}{2 π} {β}_{c , m n}$$

where v stands for the velocity of the microwave in a medium filling the waveguide, β_{c,m n} is a cutoff phase constant which is calculated for the TEₘₙ and the TMₘₙ mode according to the formulae given below:

$${TE}_{mn} mode : {β}_{c , m n} = \frac{{χ}_{mn}^{′}}{R}$$

$${TM}_{mn} mode : {β}_{c , m n} = \frac{{χ}_{mn}}{R}$$

where Xₘₙ is the n-th root of m-th Bessel function, X′ₘₙ is the n-th root of the m-th Bessel function derivative, and R is the radius of the circular waveguide structure. Some values of the Bessel functions and Bessel functions derivatives are given in the below table

| m | n | χmn | χ′mn |
|---|---|---|---|
| 0 | 1 | 2.405 | 3.832 |
| 0 | 2 | 5.520 | 7.016 |
| 0 | 3 | 8.654 | 10.173 |
| 1 | 1 | 3.832 | 1.841 |

The velocity v of the microwave in a dielectric (non-magnetic) medium is given by the following formula:

$$v = \frac{c}{\sqrt{ε\_r}}$$

where ε_r is the (static) relative dielectric permittivity of the dielectric medium (real part of the frequency dependent complex permittivity) the and c is the speed of light in vacuum. For vacuum, the (static) relative dielectric permittivity ε_r is equal to 1 and thus the velocity v of the microwave is equal to the speed of light in vacuum c.

The fundamental mode of a waveguide is the mode that has the lowest cutoff frequency. It follows from the above formulae and the given values of the Bessel functions and Bessel functions derivatives that the fundamental mode of a circular waveguide is the TE₁₁ mode. The next higher mode is TM₀₁ mode.

Where the cylindrical microwave cavity is a circular-cylindrical microwave cavity, the specific transverse magnetic mode to be excited by the coaxial feed exciter preferably is a TM₀₁ mode. The TM₀₁ mode is rotationally symmetrical which proves particularly advantageous with regard to a homogeneous heating of the aerosol-forming substrate in the distal substrate portion of the aerosol-generating article.

In order to ensure that the TM₀₁ mode will propagate into the “filled” circular-cylindrical microwave cavity of a given inner diameter D, when an aerosol-generating article comprising an aerosol-forming substrate with a static relative dielectric permittivity ε_r is received therein, the microwave generator preferably is configured to generate a microwave signal having a frequency above a cutoff frequency f_cutoff defined by the following equation [f_cutoff=(2.405*c)/(π*D*Sqrt(ε_r))]:

$$f\_cutoff = \frac{2.405 \cdot c}{π \cdot D \cdot \sqrt{ε\_r}}$$

Typically, known aerosol-forming substrates used for generating inhalable aerosols by heating (not by burning), so called “heat-not-burn” substrates, have a static relative dielectric permittivity ε_r in a range between 2 and 2.5, in particular between 2.3 and 2.4, preferably between 2.3 and 2.35. Accordingly, to enable microwave coupling into a circular-cylindrical microwave cavity, when an article comprising such an aerosol-forming substrate is received therein, the microwave generator preferably is configured to generate a microwave signal having a frequency above a cutoff frequency f_cutoff, wherein the cutoff frequency f_cutoff is a value out of a range defined by the following equation [f_cutoff=(2.405*c)/(π*D*Sqrt(ε_r))]:

$$f\_cutoff = \frac{2.405 \cdot c}{π \cdot D \cdot \sqrt{ε\_r}}$$

wherein D is the inner diameter of the circular-cylindrical microwave cavity, c is the speed of light in vacuum, and ε_r is a value in a range between 2 and 2.5, in particular between 2.3 and 2.4, preferably between 2.3 and 2.35.

Vice versa, in order to prevent or at least suppress microwave coupling into the empty circular-cylindrical microwave cavity of given inner diameter D, the microwave generator preferably is configured to generate a microwave signal having a frequency below a frequency threshold f_thresh given by the following equation [f_thresh=(2.405*c)/(π*D)]:

$$f\_thresh = \frac{2.405 \cdot c}{π \cdot D}$$

wherein D is the inner diameter of the circular-cylindrical microwave cavity, and c is the speed of light in vacuum. For any value below the above defined frequency threshold f_thresh, the frequency of the microwave signal is below the cutoff frequency of the empty microwave cavity, and thus the TM₀₁ mode will not propagate into the “empty” microwave cavity.

Solving Maxwell's equations for the boundary conditions of a rectangular waveguide results in the following formulae for the cutoff frequencies for the TEₘₙ and the TMₘₙ mode in a rectangular waveguide with side lengths a and b:

$${TE}_{mn} mode : {f}_{c , m n} = \frac{v}{2 π} \sqrt{{( \frac{m \cdot π}{a} )}^{2} + {( \frac{n \cdot π}{b} )}^{2}}$$

$${TM}_{mn} mode : {f}_{c , m n} = \frac{v}{2 π} \sqrt{{( \frac{m \cdot π}{a} )}^{2} + {( \frac{n \cdot π}{b} )}^{2}}$$

where v stands for the velocity of the microwave in a medium filling the waveguide. As can be seen, the cutoff frequencies for a TMₘₙ mode are the same as for the TEmn modes. The only difference is that one cannot have m=0 or n=0. The lowest-order TMₘₙ mode is the TM₁₁ mode, with m=1 and n=1. The lowest-order TEₘₙ mode is the TE₁₀ mode, with m=1 and n=0.

Based on the formulae for the cutoff frequencies for the TEₘₙ and the TMₘₙ mode in a rectangular waveguide, similar conditions as for a circular-cylindrical microwave cavity can be derived for a rectangular waveguide to ensure proper wave propagation into a “filled” rectangular-cylindrical microwave cavity, and to prevent or at least suppress microwave coupling into an empty rectangular-cylindrical microwave cavity.

Accordingly, in order to enable microwave coupling of, for example, the TE₁₁ mode into a rectangular-cylindrical microwave cavity, when an article comprising aerosol-forming substrate is received therein, the microwave generator preferably is configured to generate a microwave signal having a frequency above a cutoff frequency f_cutoff, wherein the cutoff frequency f_cutoff is a value out of a range defined by the following equation:

$${f}_{cutoff} = \frac{c}{2 π \cdot \sqrt{ε\_r}} \sqrt{{( \frac{π}{a} )}^{2} + {( \frac{π}{b} )}^{2}}$$

wherein a and b are the side lengths of the rectangular-cylindrical microwave cavity, c is the speed of light in vacuum, and ε_r is a value in a range between 2 and 2.5, in particular between 2.3 and 2.4, preferably between 2.3 and 2.35.

Likewise, in order to prevent or at least suppress microwave coupling of, for example, the TE₁₁ mode into an empty rectangular-cylindrical microwave cavity with side lengths a and b, the microwave generator preferably is configured to generate a microwave signal having a frequency below a frequency threshold f_thresh given by the following equation:

$$f\_thresh = \frac{c}{2 π} \sqrt{{( \frac{π}{a} )}^{2} + {( \frac{π}{b} )}^{2}}$$

wherein a and b are the side lengths of the rectangular-cylindrical microwave cavity, and c is the speed of light in vacuum.

In general, the microwave generator may be configured to generate a microwave signal in a frequency range between 5 and 50 GHz, in particular between 10 GHz and 40 GHz, preferably between 12 GHz and 18 GHz or between 20 GHz and 30 GHz, most preferably between 24 GHz and 24.25 GHz. Advantageously, these frequency ranges have proven to be suitable in order to fulfill the above conditions for reasonable dimension of the microwave cavity in a hand-held device and for typical values of the static relative dielectric permittivity ε_r of most aerosol-forming substrates. In particular, the latter frequency range between 24 GHz and 24.25 GHz corresponds to the 24-24.25 GHz ISM (Industrial, Scientific and Medical) radio band, a portion of the radio spectrum which is reserved internationally for industrial, scientific and medical (ISM) purposes (excluding applications in telecommunications). Advantageously, the ISM radio band can be used by high-frequency devices in industry, science, medicine, in domestic and similar areas license-free and mostly without authorization.

As already mentioned above, the microwave cavity preferably comprises an electrically conductive inner surface. More particularly, at least a part of an inner surface, or only a part of an inner surface or an entire inner surface of the microwave cavity may be electrically conductive. In particular, the microwave cavity may comprise an electrically conductive inner surface along the inner circumference of the microwave cavity, that is an electrically conductive circumferential inner surface, in order to provide a circular waveguide structure. In addition, the inner surface at a closed axial end, in particular a closed distal end of the microwave cavity, that is, an axial end surface of the microwave cavity, may be electrically conductive.

However, the inner surface of the microwave cavity, in particular the inner surface along the inner circumference of the microwave cavity, does not necessarily need to be electrically conductive in case the aerosol-generating article comprises a reflective shell of the substrate portion. The shell may be arranged circumferentially around the aerosol-forming substrate, in particular exclusively circumferentially around the aerosol-forming substrate. For example, the aerosol-generating article may comprise a metallic wrapper, such as an aluminum foil, circumferentially surrounding the aerosol-forming substrate. In this configuration, only the inner surface at a closed axial end, in particular a closed distal end of the microwave cavity, that is, an axial end surface of the microwave cavity, may be electrically conductive. Alternatively, the shell may be arranged circumferentially around the aerosol-forming substrate and in addition either at one axial end of the substrate portion, in particular at a distal end of the substrate portion, or at both axial ends of the substrate portion. For example, the aerosol-generating article may comprise metallic wrapper, such as an aluminum foil, fully surrounding, in particular fully encapsulating the aerosol-forming substrate.

As follows from the above formulae for the TE modes and the TM modes in a circular or rectangular waveguide, a waveguide structure does not support only one propagating mode, if the frequency of the microwave is not between the cutoff frequency of the mode with the lowest cutoff frequency and the cutoff frequency of the mode with the next lowest cutoff frequency. Hence, when the aerosol-generating device according to the present invention comprises, for example, a circular-cylindrical microwave cavity of a given inner diameter and is supposed to use the TM₀₁ mode as specific transverse magnetic mode, propagation of the fundamental mode of a circular waveguide, that is, the TE₁₁ mode, will also be supported by the microwave cavity since it has a lower cutoff frequency than the TM₀₁ mode. In order to select and excite one, in particular only one, or a selection of specific transverse magnetic modes or transverse electric modes within the microwave cavity, the structure, shape and position of the coaxial feed exciter can be advantageously used to determine the mode spectrum that is coupled into the microwave cavity, in particular. In general, there are different types and methods for coupling a microwave signal into a waveguide structure, two of them are known as probe coupling and loop coupling. In probe coupling, a probe inside a coaxial line is used to distribute energy into a waveguide. As current starts flowing in the probe, an electric field is set up and it gets detached from the probe to the waveguide. The probe (also called a probe antenna or excitation probe) radiates energy equally into the waveguide where it is inserted. In loop coupling, a conductor is inserted into the waveguide and bends into a loop. The center of the loop may be at an equal distance from the top and bottom walls of the waveguide. When current flows through the loop, it generates a magnetic field component that couples with the waveguide field.

In order to only excite one or more specific transverse magnetic modes, such the TM₀₁ mode into a circular-cylindrical microwave cavity, the coaxial feed exciter according to the present invention may comprise a coaxial line having an inner conductor surrounded by a concentric outer conductor shield, wherein a cavity-side end portion of the inner conductor extends beyond a cavity-side end of the outer conductor shield into the microwave cavity to form an excitation probe.

The coaxial feed exciter may be coupled to the microwave cavity via a feed-in opening in a closed axial end of the microwave cavity, in particular a closed distal end of the microwave cavity.

Preferably, the coaxial feed exciter is centrically arranged at a closed axial end of the microwave cavity, in particular at a closed distal end of the microwave cavity opposite a proximal open end of the microwave cavity, that is, at an axial end surface of the microwave cavity, in particular a distal end surface of the microwave cavity. More particularly, the coaxial feed exciter is coaxially arranged to the cylindrical microwave cavity. That is, a center axis of the coaxial feed exciter coincides with a center axis of the cylindrical microwave cavity.

Where the microwave cavity comprises an electrically conductive inner surface to provide a waveguide structure, a cavity-side end of the outer conductor shield preferably is connected to an electrically conductive inner surface of the microwave cavity. Advantageously, this enhances the coupling efficiency.

The coupling efficiency and resonant frequency for an optimal coupling of the microwave signal into the microwave cavity depend—inter alia—on the dimensions of the coaxial feed exciter.

Accordingly, a length of the excitation probe extending beyond the cavity-side end of the outer conductor shield into the microwave cavity may be in a range between 1 millimeter and 8 millimeter, in particular between 1 millimeter and 4 millimeter, preferably between 1 millimeter and 2 millimeter.

Likewise, a diameter of the excitation probe may be in a range between 1 millimeter and 2 millimeter, in particular between 1.2 millimeter and 1.8 millimeter, preferably between 1.4 millimeter and 1.7 millimeter.

It has been found that the above-mentioned dimensions of the coaxial feed exciter advantageously provide optimal conditions for coupling the microwave signal from the microwave generator into the microwave cavity. In particular, these dimensions help to decrease the reflection coefficient of the waveguide structure provided in the microwave cavity. Thus, higher heating temperatures may be achieved.

As mentioned above, the aerosol-generating device according to the present invention preferably is configured for use with cylindrical aerosol-generating articles having a shape and dimensions resembling those of conventional cigarettes. Hence, the dimensions of the microwave cavity preferably are chosen such as to be compatible for receiving such kind of aerosol-generating articles. Accordingly, a diameter of the microwave cavity may be in a range between 2 millimeter and 15 millimeter, in particular between 4 millimeter and 12 millimeter, preferably between 6 millimeter and 9 millimeter. Likewise, the length of the microwave cavity preferably is chosen such as to fully receive at least the substrate portion of the aerosol-generating article which contains the aerosol-forming substrate to be heated. Accordingly, a length of a distal part of the microwave cavity that is configured to receive the distal substrate portion of the aerosol-generating article may be in a range between 5 millimeter and 20 millimeter, in particular between 9 millimeter and 17 millimeter, preferably between 10 millimeter and 14 millimeter.

As can be seen from the above formulae, the specific vales of the cutoff frequencies and frequency thresholds for the TE modes and TM modes are dependent—inter alia—from the lateral dimensions, for example, the diameter of the waveguide structure the substrate portion to be heated is snuggly received in. Where it is desired to work at frequencies lower than the cutoff frequency for given lateral dimensions of the substrate portion, such as a given diameter of the substrate portion, it is suggested to increase the lateral dimensions, such as the diameter of the microwave cavity and to fill the empty space between the outer surface of the article and the inner surface of the microwave cavity with a filler. Accordingly, the aerosol-generating device may comprise an electrically non-conductive hollow cylindrical, in particular circular hollow cylindrical filler arranged within the microwave cavity, wherein an outer circumferential surface of the hollow cylindrical, in particular circular hollow cylindrical filler is in contact with an inner surface of the microwave cavity along an inner circumference of the microwave cavity, and wherein the inner void of the hollow cylindrical, in particular circular hollow cylindrical filler provides a receiving chamber configured to removably receive at least the substrate portion of the aerosol-generating article. Advantageously, this allows heat to an article of a given diameter at lower microwave frequencies by using a microwave cavity having a larger diameter than the given diameter of the article. Note, this is only applicable for device, in which the waveguide structure is provided by a reflective, in particular electrically conductive inner surface of the microwave cavity, but not for devices in which the waveguide structure is provided by a reflective outer shell of the article in the substrate portion, for example, by a metallic wrapper surrounding the aerosol-forming substrate.

For generating the microwave signal, the microwave generator preferably comprises at least one magnetron providing a source of the microwave signal. The magnetron may be coupled to the coaxial feed exciter.

The microwave generator may further comprise a microwave amplifier to provide a microwave signal of a desired outpower sufficient to heat the aerosol-forming substrate when the article is received in the microwave cavity.

The microwave generator may be configured to generate a microwave signal having an outpower in a range between 1 Watt and 10 Watt, in particular between 1.5 Watt and 10 Watt, preferably between 2 Watt and 7 Watt. Any outpower in these ranges may be sufficient to heat the aerosol-forming substrate to the desired temperatures.

As used herein, the term “aerosol-generating device” generally refers to an electrically operated device that is capable of interacting with an aerosol-forming substrate provided within an aerosol-generating article, such as to generate an aerosol by heating the substrate. Preferably, the aerosol-generating device is a puffing device for generating an aerosol that is directly inhalable by a user thorough the user's mouth. In particular, the aerosol-generating device is a hand-held aerosol-generating device.

Preferably, the microwave cavity comprises at least one open axial end, in particular a proximal open end, which may serve as an insertion opening through which an aerosol-generating article may be inserted into the microwave cavity. As used herein, the direction in which the aerosol-generating article is inserted is denoted as insertion direction. Preferably, the insertion direction corresponds to the extension of the center axis of the cylindrical microwave cavity. Upon insertion into the microwave cavity, at least a portion of the aerosol-generating article may still extend outwards through the open axial end, in particular the proximal open end. The outwardly extending portion preferably may be provided for interaction with a user, in particular for being taken into a user's mouth. Hence, during use of the device, the axial open end may be close to the user's mouth and thus denoted as proximal open end. Accordingly, sections close to the proximal open end or close to a user's mouth in use of the device, respectively, are denoted with the prefix “proximal”. Sections which are arranged further away are denoted with the prefix “distal”. Correspondingly, as used herein “proximal” may imply a direction towards a user of the device, whereas “distal” may imply a direction opposite to the proximal direction, that is, away from a user of the device. The insertion direction may preferably be a distal direction.

The microwave cavity may be arranged or located in a proximal portion of the aerosol-generating device. Likewise, the proximal open end may be arranged or located at a proximal end of the aerosol-generating device.

The microwave cavity may comprise a sleeve or tube forming the circumferential side walls of the cavity. Furthermore, the microwave cavity may comprise a bottom portion which may form a closed axial end, in particular a closed distal end of the microwave cavity. Likewise, the microwave cavity may be formed by or may comprise a barrel. The microwave cavity, in particular the sleeve, tube, bottom portion and barrel, may be inserted within a device housing, in particular within a proximal portion of a device housing of the aerosol-generating device. The device housing preferably is made of plastic. The device may further comprise a thermal insulation material arranged between the microwave cavity and the device housing. The thermal insulation material may be configured to provide thermal insulation to sustain heat within the microwave cavity and to prevent heat conduction between the interior of the chamber and the device housing.

The microwave cavity may comprise or may be made of metal, such as stainless steel or aluminum, in particular when the waveguide structure is realized by the microwave cavity itself. Alternatively, the microwave cavity may comprise or may be made of plastic, in particular a thermoplastic, such as PEEK (polyether ether ketone). PEEK is a semi-crystalline thermoplastic with excellent mechanical and chemical resistance properties that are retained to high temperatures. Where the waveguide structure is realized by the microwave cavity itself, the inner surface of microwave cavity comprising or being made of plastic may formed by an electrically conductive coating, such as metallic coating.

The microwave cavity may also be integral with at least a part of the coaxial feed exciter. In particular, the microwave cavity may be integral at least with the outer conductor shield of the coaxial feed exciter. Advantageously, this may facilitate the manufacture of the aerosol-generating device.

The aerosol-generating device may further comprise a controller configured to control operation of the device. In particular, the controller may be configured to control the microwave generator, preferably in a closed-loop configuration, for controlling heating of the aerosol-forming substrate to a pre-determined operating temperature. The operating temperature used for heating the aerosol-forming substrate may be at least 180 degree Celsius, in particular at least 300 degree Celsius, preferably at least 350 degree Celsius, more preferably at least 370 degree Celsius, most preferably at least 400 degree Celsius.

The aerosol-generating device may comprise a power supply, in particular a DC power supply configured to provide a DC supply voltage and a DC supply current to power the microwave generator. Preferably, the power supply is a battery, in particular a rechargeable battery, such as a lithium iron phosphate battery.

The microwave generator, the coaxial feed exciter and the microwave cavity as described herein together may be part of or may form a microwave heating arrangement for heating an aerosol-forming substrate. The microwave heating arrangement may an independent aspect of the present invention.

According to the present invention, there is also provided an aerosol-generating system comprising an aerosol-generating device according to the present invention and as described herein. The system further comprise a cylindrical aerosol-generating article comprising a distal substrate portion containing an aerosol-forming substrate to be heated by the device, when the article is received in the device housing.

As used herein, the term “aerosol-generating article” refers to an article comprising at least one aerosol-forming substrate that, when heated, releases volatile compounds that can form an aerosol. Accordingly, the aerosol-generating article may be denoted as “heated aerosol-generating article” or “aerosol-generating article for heating” or “heat-not-burn article”. That is, the aerosol-generating article comprises at least one aerosol-forming substrate that is intended to be heated rather than combusted in order to release volatile compounds that can form an aerosol. The aerosol-generating article may be a consumable, in particular a consumable to be discarded after a single use.

As used herein, the term “aerosol-forming substrate” relates to a substrate capable of releasing volatile compounds that can form an aerosol when heated. The aerosol-forming substrate may be a solid aerosol-forming substrate or a gel-like aerosol-forming substrate or a liquid aerosol-forming substrate or a combination thereof. The aerosol-forming substrate may comprise a tobacco-containing material containing volatile tobacco flavor compounds, which are released from the substrate upon heating. Alternatively or additionally, the aerosol-forming substrate may comprise a non-tobacco material. The aerosol-forming substrate may further comprise an aerosol former. Examples of suitable aerosol formers are glycerin and propylene glycol. The aerosol-forming substrate may also comprise other additives and ingredients, such as nicotine or flavoring substances. In particular, liquid aerosol-forming substrate may include water, solvents, ethanol, plant extracts and natural or artificial flavors. The aerosol-forming substrate may also be a paste-like material, a sachet of porous material comprising aerosol-forming substrate, or, for example, loose tobacco mixed with a gelling agent or sticky agent, which could include a common aerosol former such as glycerin, and then is compressed or molded into a plug. The aerosol-generating article may be a tobacco article.

As used herein, the term “cylindrical aerosol-generating article” refers to an aerosol-generating article in which at least the distal substrate portion of the cylindrical aerosol-generating article is cylindrical, that is, has a cylindrical shape. The term “cylindrical aerosol-generating article” may also refer to an aerosol-generating articles for which the entire article is cylindrical, that is, has a cylindrical shape. In particular, the article may be a rod-shaped article, which may resemble conventional cigarettes.

Preferably, the outer shape and diameter of at least the distal substrate portion, in particular of the entire aerosol-generating article matches the shape and diameter of the circular waveguide structure provided in the microwave cavity. Where the waveguide structure is realized by the microwave cavity itself, the outer shape and diameter of at least the distal substrate portion, in particular of the entire aerosol-generating article may match the shape and diameter of in the microwave cavity. In particular, when the microwave cavity is a circular-cylindrical microwave cavity, at least the distal substrate portion, in particular the entire aerosol-generating article has a circular-cylindrical shape. Likewise, when the microwave cavity is a rectangular-cylindrical microwave cavity, at least the distal substrate portion, in particular the entire aerosol-generating article has a rectangular-cylindrical shape.

The distal substrate portion of the article may have a length (along a length axis of the cylindrical aerosol-generating article) in a range between 5 millimeter and 20 millimeter, in particular between 9 millimeter and 17 millimeter, preferably between 10 millimeter and 14 millimeter.

According to the invention, the cylindrical microwave cavity is configured to removably receive at least the distal substrate portion of the aerosol-generating article. Accordingly, the microwave cavity has a length at least equal to or greater than the length of the distal substrate portion. Accordingly, the microwave cavity, or at least a distal part of the microwave cavity that is configured to receive the substrate portion of the aerosol-generating article, may have a length at least in a range between 5 millimeter and 20 millimeter, in particular between 9 millimeter and 17 millimeter, preferably between 10 millimeter and 14 millimeter.

As an example, the aerosol-generating article may comprise one or more of the following elements: a substrate element, a first tube element, a second tube element, and a filter element.

The substrate element preferably comprises the at least one aerosol-forming substrate to be heated. In particular, the substrate element may be part of or form the distal substrate portion of the article. Accordingly, the substrate element may have a length corresponding to the length of the distal substrate portion. Given that, the substrate element may have a length (along a length axis of the cylindrical aerosol-generating article) in a range between 5 millimeter and 20 millimeter, in particular between 9 millimeter and 17 millimeter, preferably between 10 millimeter and 14 millimeter.

The first tube element is more distal than the second tube element. Preferably, the first tube element is proximal of the substrate element, whereas the second tube element is proximal of the first tube element and distal of the filter element, that is, between the first tube element and the filter element. At least one of the first tube element and the second tube element may comprise a central air passage. A cross-section of the central air passage of the second tube element may be larger than a cross-section of the central air passage of the first tube element. Preferably, at least one of the first tube element and the second tube element may comprise a hollow cellulose acetate tube. At least one of the first tube element and the second tube element may have a length of 6 millimeter to 10 millimeter, for example, 8 millimeters.

The filter element preferably serves as a mouthpiece, or as part of a mouthpiece together with the second tube element. As used herein, the term “mouthpiece” refers to a portion of the article through which the aerosol exits the aerosol-generating article. The filter element may have a length of 10 millimeter to 14 millimeter, for example, 12 millimeter.

All of the aforementioned elements may be sequentially arranged along a length axis of the article in the above described order, wherein the substrate element preferably is arranged at a distal end of the article and the filter element preferably is arranged at a proximal end of the article. All of the aforementioned elements may have the same outer cross-sectional shape and/or dimensions.

In addition, the elements may be circumscribed by one or more outer wrappers such as to keep the elements together and to maintain the desired cross-sectional shape of the rod-shaped article. Preferably, the wrapper is made of paper. Alternatively, the wrapper may be made of a metallic foil, such as an aluminum foil in order to provide a cylindrical waveguide structure, as described above. The wrapper may further comprise adhesive that adheres the overlapped free ends of the wrapper to each other.

As stated further above, the distal substrate portion of the article preferably has a static relative dielectric permittivity larger than the more proximal portions of the aerosol-generating article, in order to prevent or at least reduce leakage of the microwave field beyond the proximal end of the distal substrate portion.

Accordingly, the aerosol-generating article may comprise a proximal portion proximally adjacent to the distal portion, wherein a mean static relative dielectric permittivity of the proximal portion is lower than a static relative dielectric permittivity of the aerosol-forming substrate contained in the distal substrate portion. Likewise, a material of the proximal portion axially facing the distal substrate portion may have a static relative dielectric permittivity lower than a static relative dielectric permittivity of the aerosol-forming substrate contained in the distal substrate portion. For example, the proximal portion may comprise at least the first tube element mentioned above. In addition, the proximal portion may comprise at least one of the second tube element and the filter element mentioned above. The material of the proximal portion axially facing the distal substrate portion may be a material of the first tube element, for example, cellulose acetate, and/or air in the inner void of first tube element. Likewise, a mean static relative dielectric permittivity of the proximal portion may be given by the average value of the static relative dielectric permittivity of cellulose acetate and air, preferably weighted by their respective mass or volume fraction in the first tube element.

A (weighted) mean static relative dielectric permittivity of the proximal portion may be in a range between 1 and 1.5. Likewise, the material of the proximal portion axially facing the distal substrate portion may have a static relative dielectric permittivity in a range between 1 and 1.5.

As already mentioned above with respect to the aerosol-generating device, the aerosol-forming substrate may have a static relative dielectric permittivity in a range between 2 and 2.5, in particular between 2.3 and 2.4, preferably between 2.3 and 2.35.

Preferably, the aerosol-forming substrate may have a dielectric loss tangent (tan δ) in a range between 0.05 and 0.2, in particular between 0.1 and 0.15, for example about 0.11. The dielectric loss tangent (tan δ) of a material denotes quantitatively dissipation of the electrical energy due to different physical processes such as electrical conduction, dielectric relaxation, dielectric resonance and loss from non-linear processes.

Where the microwave cavity has a circular cross-sectional shape, the microwave generator may be configured to generate a microwave signal having a frequency above a cutoff frequency f_cutoff given by the following equation [f_cutoff=(2.405*c)/(π*D*Sqrt(ε_r))]:

$$f\_cutoff = \frac{2.405 \cdot c}{π \cdot D \cdot \sqrt{ε\_r}}$$

wherein D is the inner diameter of the microwave cavity, c is the speed of light in vacuum, and ε_r is the static relative dielectric permittivity of the aerosol-forming substrate. Advantageously, this condition ensures that the TM₀₁ mode, which is a preferred mode for microwave heating in a circular-cylindrical microwave cavity due to its rotational symmetry, can propagate into the “filled” microwave cavity.

Likewise, where the microwave cavity has a rectangular cross-sectional shape, the microwave generator may be configured to generate a microwave signal having a frequency above a cutoff frequency f_cutoff given by the following equation

$${f}_{cutoff} = \frac{c}{2 π \cdot \sqrt{ε\_r}} \sqrt{{( \frac{π}{a} )}^{2} + {( \frac{π}{b} )}^{2}}$$

wherein a and b are the side lengths of the rectangular-cylindrical microwave cavity, c is the speed of light in vacuum, and ε_r is the static relative dielectric permittivity of the aerosol-forming substrate. This condition enables microwave coupling of, for example, the TE₁₁ mode into the “filled” rectangular-cylindrical microwave cavity.

Further features and advantages of the aerosol-generating system and the aerosol-generating article according to the present invention have already been described above with regard to aerosol-generating device and thus equally apply.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating device for generating an aerosol by microwave heating of an aerosol-forming substrate contained in a distal substrate portion of a cylindrical aerosol-generating article, the aerosol-generating device comprising:
a microwave generator configured to generate a microwave signal;
a cylindrical microwave cavity configured to removably receive at least the distal substrate portion of the aerosol-generating article;
a coaxial feed exciter operatively connected to the microwave generator and coupled to the microwave cavity such as to feed the microwave signal into the microwave cavity and excite at least one specific transverse magnetic mode or transverse electric mode within the microwave cavity (when the substrate portion of the article is received in the microwave cavity).

Example Ex2: The aerosol-generating device according to example Ex1, wherein the cylindrical microwave cavity is a circular-cylindrical microwave cavity or a rectangular-cylindrical microwave cavity.

Example Ex2a: The aerosol-generating device according to any one of the preceding examples, wherein the microwave cavity has at least one closed axial end, in particular a distal closed end.

Example Ex2b: The aerosol-generating device according to any one of the preceding examples, wherein the microwave cavity has at least one open axial end, in particular a proximal open end.

Example Ex3: The aerosol-generating device according to any one of the preceding examples, wherein the specific transverse magnetic mode is a TM01 mode.

Example Ex4: The aerosol-generating device according to any one of the preceding examples, wherein the microwave cavity is a circular-cylindrical microwave cavity and wherein the microwave generator is configured to generate a microwave signal having a frequency below a frequency threshold f_thresh given by the following equation: f_thresh=(2.405*c)/(π*D), wherein D is the inner diameter of the microwave cavity, and c is the speed of light in vacuum.

Example Ex5: The aerosol-generating device according to any one of the preceding examples, wherein the microwave cavity is a circular-cylindrical microwave cavity and wherein the microwave generator is configured to generate a microwave signal having a frequency above a cutoff frequency, the cutoff frequency having a value out of a range defined by the following equation: f_cutoff=(2.405*c)/(π*D*Sqrt(ε_r)), wherein D is the inner diameter of the microwave cavity, c is the speed of light in vacuum, and ε_r is a value in a range between 2 and 2.5, in particular between 2.3 and 2.4, preferably between 2.3 and 2.35.

Example Ex6: The aerosol-generating device according to any one of the preceding examples, wherein the microwave generator is configured to generate a microwave signal in a frequency range between 5 and 50 GHz, in particular between 10 GHz and 40 GHz, preferably between 12 GHz and 18 GHz or between 20 GHz and 30 GHz, for example between 24 GHz and 24.25 GHz.

Example Ex7: The aerosol-generating device according to any one of the preceding examples, wherein the microwave cavity comprises an electrically non-conductive inner surface, or wherein at least a portion of an inner surface of the microwave cavity, in particular at least one of an inner surface at a closed axial end, in particular at a closed distal end, of the microwave cavity and an inner surface along an inner circumference of the microwave cavity, is electrically conductive.

Example Ex8: The aerosol-generating device according to any one of the preceding examples, further comprising an electrically non-conductive hollow cylindrical, in particular circular hollow cylindrical filler arranged within the microwave cavity, wherein an outer circumferential surface of the hollow cylindrical, in particular circular hollow cylindrical filler is in contact with an inner surface of the microwave cavity along an inner circumference of the microwave cavity, and wherein the inner void of the hollow cylindrical, in particular circular hollow cylindrical filler provides a receiving chamber configured to removably receive at least the substrate portion of the aerosol-generating article.

Example Ex9: The aerosol-generating device according to any one of the preceding examples, wherein the coaxial feed exciter comprises a coaxial line having an inner conductor surrounded by a concentric outer conductor shield, wherein a cavity-side end portion of the inner conductor extends beyond a cavity-side end of the outer conductor shield into the microwave cavity to form an excitation probe.

Example Ex10: The aerosol-generating device according to example Ex9, wherein a length of the excitation probe extending beyond the cavity-side end of the outer conductor shield into the microwave cavity is in a range between 1 millimeter and 8 millimeter, in particular between 1 millimeter and 4 millimeter, preferably between 1 millimeter and 2 millimeter.

Example Ex11: The aerosol-generating device according to example Ex9 or example Ex10, wherein a diameter of the excitation probe is in a range between 1 millimeter and 2millimeter, in particular between 1.2 millimeter and 1.8 millimeter, preferably between 1.4 millimeter and 1.7 millimeter.

Example Ex12: The aerosol-generating device according to any one of examples Ex9 to Ex11, wherein a cavity-side end of the outer conductor shield is connected to an electrically conductive inner surface of the microwave cavity.

Example Ex13: The aerosol-generating device according to any one of the preceding examples, wherein the microwave cavity is a circular-cylindrical microwave cavity and wherein a diameter of the microwave cavity is in a range between 2 millimeter and 15 millimeter, in particular between 4 millimeter and 12 millimeter, preferably between 6 millimeter and 9 millimeter.

Example Ex14: The aerosol-generating device according to any one of the preceding examples, wherein a length of a distal part of the microwave cavity configured to receive the substrate portion of the aerosol-generating article is in a range between 5 millimeter and 20 millimeter, in particular between 9 millimeter and 17 millimeter, preferably between 10 millimeter and 14 millimeter.

Example Ex15: The aerosol-generating device according to any one of the preceding examples, wherein the microwave generator comprises a magnetron.

Example Ex16: The aerosol-generating device according to any one of the preceding examples, wherein the microwave generator comprises a microwave amplifier.

Example Ex17: The aerosol-generating device according to any one of the preceding examples, wherein the microwave generator is configured to generate a microwave signal having an outpower in a range between 1 Watt and 10 Watt, in particular between 1.5 Watt and 10 Watt, preferably between 2 Watt and 7 Watt.

Example Ex18: An aerosol-generating system comprising an aerosol-generating device according to any one of the preceding examples, and a cylindrical aerosol-generating article comprising a distal substrate portion containing an aerosol-forming substrate.

Example Ex19: The aerosol-generating system according to example Ex18, wherein the aerosol-generating article comprises a proximal portion proximally adjacent to the distal portion, wherein a material of the proximal portion axially facing the distal substrate portion has a static relative dielectric permittivity lower than a static relative dielectric permittivity of the aerosol-forming substrate contained in the distal substrate portion.

Example Ex20: The aerosol-generating system according to example Ex19, wherein the material of the proximal portion axially facing the distal substrate portion has a static relative dielectric permittivity in a range between 1 and 1.5.

Example Ex21: The aerosol-generating system according to any one of examples Ex18 to Ex20, wherein the aerosol-forming substrate has a static relative dielectric permittivity in a range between 2 and 2.5, in particular between 2.3 and 2.4, preferably between 2.3 and 2.35.

Example Ex22: The aerosol-generating system according to any one of examples Ex18 to Ex21, wherein the microwave generator is configured to generate a microwave signal having a frequency above a cutoff frequency f_cutoff given is following equation f_cutoff=(2.405*c)/(π*D*Sqrt(ε_r)), wherein D is the inner diameter of the microwave cavity, c is the speed of light in vacuum, and ε_r is the static relative dielectric permittivity of the aerosol-forming substrate.

Example Ex23: The aerosol-generating system according to any one of examples Ex18 to Ex22, wherein the distal substrate portion has a length (along a length axis of the cylindrical aerosol-generating article) in a range between 5 millimeter and 20 millimeter, in particular between 9 millimeter and 17 millimeter, preferably between 10 millimeter and 14 millimeter.

Examples will now be further described with reference to the figures in which:

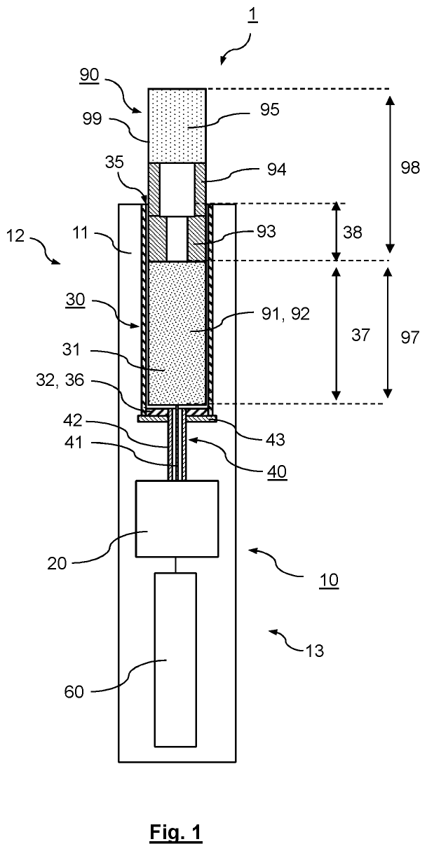

FIG. 1 schematically illustrates in a sectional view an exemplary embodiment of an aerosol-generating system according to the present invention, comprising an aerosol-generating device and aerosol-generating article;

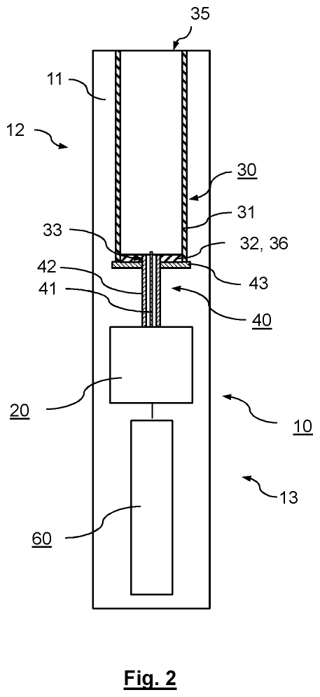

FIG. 2 shows the aerosol-generating device of the aerosol-generating system according to FIG. 1 without the aerosol-generating article;

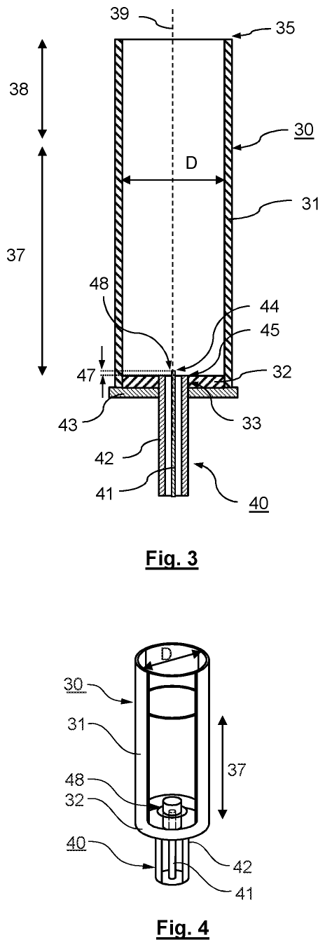

FIG. 3 shows details of the microwave cavity and the coaxial feed exciter of the device shown in FIG. 1 and FIG. 2;

FIG. 4 shows a schematic perspective view of the microwave cavity and the coaxial feed exciter of the device shown in FIG. 1 and FIG. 2;

FIG. 5 shows for different values of the dielectric permeability ε_r the cutoff frequency f_cutoff of the TE₁₁ mode in a circular waveguide structure as a function of the waveguide radius D/2 (half diameter D);

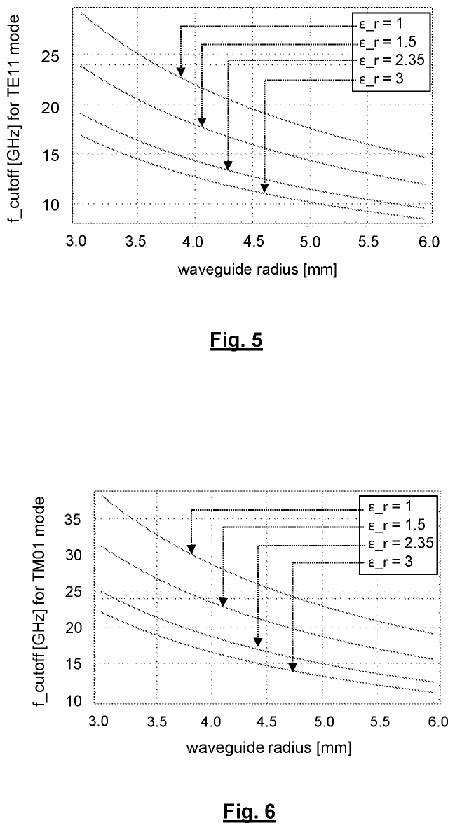

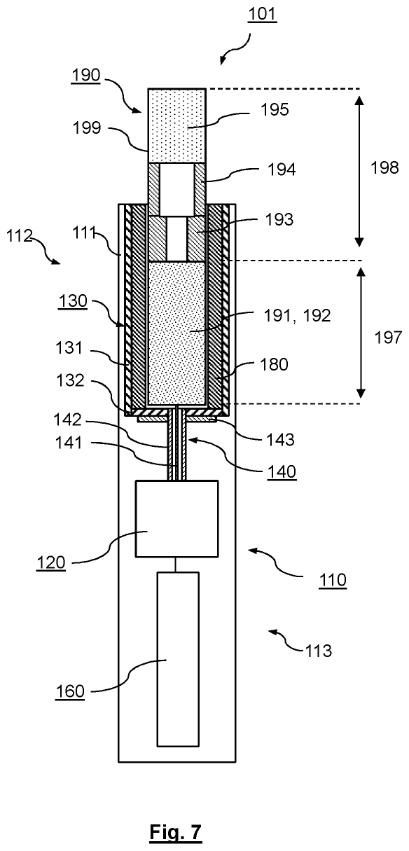

FIG. 6 shows for different values of the dielectric permeability ε_r the cutoff frequency f_cutoff of the TM₀₁ mode in a circular waveguide structure as a function of the waveguide radius D/2 (half diameter D);

FIG. 7. shows an aerosol-generating system according to an alternative embodiment of the present invention, comprising an aerosol-generating device having a hollow cylindrical filler arranged within the microwave cavity; and

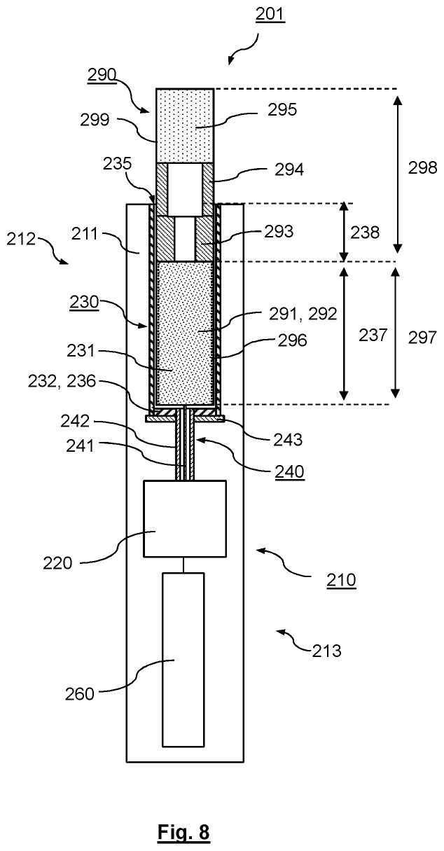

FIG. 8 shows an aerosol-generating system according to a yet another embodiment of the present invention, comprising an aerosol-generating device with an inner surface of the microwave cavity being non-conductive, and an aerosol-generating article with an aerosol-forming substrate comprising a conductive outer shell.

FIG. 1 and FIG. 2 schematically illustrate an exemplary embodiment of an aerosol-generating system 1 according to the present invention that is configured for generating an inhalable aerosol by microwave heating of an aerosol-forming substrate 92. The system 1 comprises an aerosol-generating article 90 containing the aerosol-forming substrate 92 to be heated, and an aerosol-generating device 10 which includes a microwave heating arrangement for heating the substrate 92 upon engaging the article 90 with the device 10.

As shown in FIG. 1, the aerosol-generating article 90 is a cylindrical article having a substantially rod-like shape resembling the shape of a conventional cigarette. In the present embodiment, the article 90 comprises four elements which are sequentially arranged in coaxial alignment along a length axis of the article 90: a substrate element 91, a first tube element 93, a second tube element 94, and a filter element 95. The four elements 91, 93, 94, 95 are circumscribed by an outer wrapper 99 such as to keep the four elements together and to maintain the desired circular cross-sectional shape of the rod-like article 90. The wrapper 99 preferably is made of paper. Details of these elements have already been described further above. The filter element 95 is arranged at a proximal end serving as a mouthpiece. The substrate element 91 is arranged at a distal end of the article 90 and comprises the aerosol-forming substrate 92 to be heated. Accordingly, the substrate element 91 may be considered to form a distal substrate portion 97 of the article 90. Vice versa, the first tube element 93, the second tube element 94, and the filter element 95 may be considered to form a proximal portion 98 of the article 90.

The elongate aerosol-generating device 10 comprises two portions: a proximal portion 12 and a distal portion 13. In the proximal portion 12, the device 10 comprises a cylindrical microwave cavity 30 for receiving at least the distal substrate portion 97 of the aerosol-generating article 90. The microwave cavity 30 has a closed distal end 36 and a proximal open end 35 which provides an insertion opening for inserting the article 90 into the microwave cavity 30. In the distal portion 13, the device 10 comprises a DC power source 60, such as a rechargeable battery, for powering operation of the device, and microwave generator 20 that is configured to generate a microwave signal. The microwave generator 20 preferably comprises at least one magnetron as a source of the microwave signal, and a microwave amplifier to provide a desired outpower sufficient to heat the aerosol-forming substrate 92 when the article 90 is received in the microwave cavity 30.

In order to feed the microwave signal into the microwave cavity 30, the aerosol-generating device 10 further comprises a coaxial feed exciter 40 that is operatively connected to the microwave generator 20 and coupled to the microwave cavity 30 via a feed-in opening 33 in the closed distal end 36 of the microwave cavity 30. The geometry and feed-in position of the coaxial feed exciter 40 is chosen such as to feed the microwave signal into the microwave cavity in order to excite at least one specific transverse magnetic mode or transverse electric mode within the microwave cavity 30 when the substrate portion 97 of the article 90 is received in the microwave cavity 30. Further details of the microwave generator 20, the coaxial feed exciter 40 and the microwave cavity 30 will be described further below.

The microwave generator 20, the coaxial feed exciter 40 and the microwave cavity 30 together form part of a microwave heating arrangement for heating the aerosol-forming substrate 92 within the distal substrate portion 97 upon insertion of the article 90 into the device 10. Details of this microwave heating arrangement, in particular of the coaxial feed exciter 40 and the microwave cavity 30, are illustrated in FIG. 3 and FIG. 4. As can be particularly seen in FIG. 2, FIG. 3 and FIG. 4, the microwave cavity 30 according to the present embodiment has a circular-cylindrical shape. The cavity 30 is formed by a circular-cylindrical sleeve 31 and a bottom portion 32 which are arranged in the proximal portion 12 of the device 10, more particularly in a proximally open chamber formed within the device housing 11. The sleeve 31 forms the side walls and the bottom portion 32 forms the closed distal end 36 of the microwave cavity 30. While the surrounding device housing 11 preferably is made of plastic, the microwave cavity 30, in particular the sleeve 31 and the bottom portion 32 are made of metal, such as stainless steel or aluminum. Due to this, the inner surface of the microwave cavity 30 at the closed distal end 36 and along the inner circumference of the microwave cavity 30 is electrically conductive and thus reflective for microwaves. As a result, the microwave cavity 30, in particular the circular-cylindrical sleeve 31 provides a circular waveguide structure that supports microwave propagation along the axial direction of the cylindrical microwave cavity 30.

According the present invention, the waveguide structure is used to realize a hollow resonator configuration for heating the substrate 92 within the distal substrate portion 97 of the aerosol-generating article 90. For this, the dimensions of the microwave cavity 30, the frequency of the microwave signal provided as well as the dielectric permeability of the aerosol-forming substrate 92 in the distal substrate portion 97 and the dielectric permeability of the materials in the proximal portion 98 of the article 90, in particular the material of the first tube element 93, are chosen such that the frequency of the microwave signal is on the one hand above the cutoff frequency for microwave propagation in the distal part 37 of the microwave cavity 30 is filled by the distal substrate portion 97, but on the other hand below the cutoff frequency for microwave propagation in the proximal part 38 of the microwave cavity 30 which receives parts of the proximal portion 98 of the article 90.

The cutoff frequencies f_cutoff for the two lowest transverse modes, that is, the TE₁₁ mode and the TM₀₁ mode, of a circular waveguide structure having a diameter D and being filled with a medium having dielectric permeability ε_r are given by the following formula:

$${TE}_{11} mode : f\_cutoff = \frac{1.841 \cdot c}{π \cdot D \cdot \sqrt{ε\_r}}$$

$${TM}_{01} mode : f\_cutoff = \frac{2.405 \cdot c}{π \cdot D \cdot \sqrt{ε\_r}}$$

FIG. 5 and FIG. 6 show for different values of the dielectric permeability ε_r the cutoff frequency f_cutoff of a circular waveguide structure as a function of the waveguide radius D/2 (half diameter D), on the one hand for the TE₁₁ mode (see FIG. 5), and on the other hand for the TM₀₁ mode (see FIG. 6). The value of ε_r=2.35 corresponds to a typically value of the dielectric permeability of the aerosol-forming substrate 92, whereas the dielectric permeability of the materials in the proximal portion 98 of the article 90, in particular the material of the first tube element 93, less than 1.5, in particular close to 1. Given that, the graphs in FIG. 5 and FIG. 6 indicate illustratively that, for example, for a waveguide radius D/2 of 3.5 millimeter (see vertical dashed line) and an operating frequency of about 24 GHz (see horizontal dashed line), both the TE₁₁ mode and the TM₀₁ mode will propagate through those parts of the microwave cavity 30, which in use are filled with aerosol-forming substrate 92, that is, the distal part 37 of the microwave cavity 30. This is because there the operating frequency of 24 GHz is above the respective cutoff frequency f_cutoff of both modes for a dielectric permeability of ε_r=2.3 (dielectric permeability of the aerosol-forming substrate 92). In contrast, in the empty microwave cavity 30 or in those parts of the microwave cavity 30, which in use are filled by the proximal portion 98 of the article 90, that is, the proximal part 38 of the microwave cavity 30, the waveguide structure cannot carry the TE₁₁ mode and the TM₀₁ mode. This is because there the operating frequency of 24 GHz is below the respective cutoff frequency f_cutoff of both modes for a value of ε_r close to 1, which corresponds to the dielectric permeability of air, and thus of an empty cavity 30, or of the proximal portion 98 of the article 90.

Hence, in use, when an aerosol-generating article 90 is received in the microwave cavity 30, the TE₁₁ mode and the TM₀₁ can propagate through the distal substrate portion 97 of the article 90. Yet, at the interface between the distal substrate portion 97 and the proximal portion 98 of the article 90, the change of the dielectric permeability prevents the microwaves from further propagating beyond the proximal end of the substrate portion 97 (exponentially decaying evanescent wave). Instead, the microwaves are reflected back into the distal direction. The same effect occurs at the distal end of the substrate portion 97, where a similar change of the dielectric permeability down to lower values, in particular down to the dielectric permeability of air, may occur, for example, due a small air pocket between the closed distal end 36 of the microwave cavity 30 and the distal end of the article 90 when received in the microwave cavity 30. Ultimately, the inner surface of the microwave cavity 30 at the closed distal end 36 is electrically conductive and thus causes a reflection of the microwaves back into the proximal direction. As a result, microwaves, which are fed into the substrate portion 97 when the article 90 is received in the microwave cavity 30, undergo reflection at both ends of the substrate portion 97 which effectively corresponds to a resonator configuration.

Vice versa, when no article is received in the microwave cavity 30, propagation of the TE₁₁ mode and the TM₀₁ through the empty microwave cavity 30 (only filled with air) is not supported and thus leakage of the microwave field from the proximal open end 35 of the microwave cavity 30 is sufficiently suppressed.

As stated above, the frequency of the microwave signal preferably is chosen to be within the 24-24.25 GHz ISM (Industrial, Scientific and Medical) radio band, which can be used by high-frequency devices in industry, science, medicine, in domestic and similar areas license-free and mostly without authorization. This frequency range is also well-suited to fulfill the above conditions for reasonable dimension of the microwave cavity in a hand-held device and reasonable dimension of an aerosol-generating article that resembles the shape and dimensions of conventional cigarettes. In the present embodiment, the diameter D of the microwave cavity 30 is about 7 millimeter, whereas a length of a distal part 37 of the microwave cavity 30 for receiving the distal substrate portion 97 of the article 90 is about 12 millimeter. Accordingly, the diameter of the article 90 (at least in the substrate portion 97) preferably is slightly smaller than 7 millimeter, and the length of the substrate portion 97 is also at about 12 millimeter. As shown in FIG. 1 and FIG. 2, the microwave cavity 30 of the present embodiment extends up to the proximal end of the device 10. Alternatively, the microwave cavity may be shorter and extend only up to the proximal end of the distal part 37 of the cavity 30 shown in in FIG. 1 and FIG. 2. That is, such a microwave cavity would not have a proximal part 38 as the microwave cavity 30 shown in in FIG. 1 and FIG. 2.

As explained above, the microwave cavity 30 of the present embodiment would carry both the TE₁₁ mode and the TM₀₁ mode for a frequency of the microwave signal at about 24 GHz and a waveguide diameter D/2 of 3.5 millimeter. However, the TM₀₁ mode is more preferred for heating the aerosol-forming substrate 92 since it is rotationally symmetric and thus provides a more homogeneous heating. In order to select this specific mode, the structure, shape and position of the coaxial feed exciter 40 can be advantageously used to determine the mode spectrum that is coupled into the microwave cavity 30. Accordingly, the coaxial feed exciter 40 of the present embodiment comprises a coaxial line having an inner conductor 41 surrounded by a concentric outer conductor shield 42. A cavity-side end portion 44 of the inner conductor 41 extends beyond a cavity-side end 45 of the outer conductor shield 42 into the microwave cavity 30 to form an excitation probe 48. In the present embodiment, a length 47 of the excitation probe 48 extending beyond the cavity-side end 45 of the outer conductor shield 42 into the microwave cavity 30 preferably is in a range between 1 millimeter and 2 millimeter. Likewise, a diameter of the excitation probe 48 preferably is in a range between 1.4 millimeter and 1.7 millimeter. It has been found that these dimensions of the coaxial feed exciter 40 advantageously provide optimal conditions for coupling the microwave signal from the microwave generator 20 into the microwave cavity 30. In particular, these dimensions help to decrease the reflection coefficient of the waveguide structure provided in the microwave cavity 30. Thus, higher heating temperatures may be achieved.

As can be seen from FIG. 3 and FIG. 4, the coaxial feed exciter 40 is coupled to the microwave cavity 30 via a feed-in opening 33 in the closed distal end 36 of the microwave cavity 30, more particularly via a feed-in opening 33 in the bottom portion 32 of the microwave cavity 30. The coaxial feed exciter 40 is coaxially arranged to the cylindrical microwave cavity 30. That is, the center axis of the coaxial feed exciter 40 coincides with a center axis 39 of the cylindrical microwave cavity 30. The coaxial feed exciter 40 may further comprise a flange 43 for attaching the distal outer surface of the bottom portion 32 of the microwave cavity 30. As can be further seen, the cavity-side end 45 of the outer conductor shield 42 is connected to the electrically conductive inner surface of the microwave cavity 30. Advantageously, this enhances the coupling efficiency. Preferably, the coaxial feed exciter 40, in particular the inner conductor 41, the outer conductor shield 42 and the flange 43, are made of the same material as the microwave cavity 30, in particular the sleeve 31 and the bottom portion 32.

As can be seen from the above formulae, the specific vales of the cutoff frequencies and the frequency thresholds for the TE modes and TM modes are dependent—inter alia—from the diameter of the circular waveguide structure the substrate portion to be heated is snuggly received in. Where it is desired to work at frequencies lower than the cutoff frequency for a given diameter of the substrate portion, the diameter of the microwave cavity can be increased, and the empty space between the outer surface of the article and the inner surface of the microwave cavity can be filled with a filler. This is illustrated in FIG. 7, which shows an aerosol-generating system 101 according to an alternative embodiment of the present invention. The system 101 comprises an aerosol-generating device 110 which is very similar to the device shown in FIG. 1 and FIG. 2. Therefore, identical or similar features are denoted with the same reference signs, yet incremented by 100. In contrast to the device 10 shown in FIG. 1 and FIG. 2, the microwave cavity 130 of the device 110 shown in FIG. 7 has a larger diameter, while the article 190 to be used with this device 110 is the same as the article 90 shown in FIG. 1. To fill the empty space between the outer surface of the article 190 and the inner surface the microwave cavity 130 along the inner circumference of the sleeve 131, the device 110 comprises an electrically non-conductive circular hollow cylindrical filler 180 arranged within the microwave cavity 130. An outer circumferential surface of the circular hollow cylindrical filler 180 is in contact with the inner surface along the inner circumference of the sleeve 131. The inner void of the circular hollow cylindrical filler 180 provides a receiving chamber configured to removably receive at least the substrate portion 197 of the aerosol-generating article 190. Advantageously, this allows heat to an article of a given diameter at lower microwave frequencies by using a microwave cavity 130 having a larger diameter than the given diameter of the article 190.

FIG. 8 shows an aerosol-generating system 201 according to yet another embodiment of the present invention. The system 201 comprises an aerosol-generating device 210 and an aerosol-generating article 290 which are very similar to the device 10 and the article 90 shown in FIG. 1. Therefore, identical or similar features are denoted with the same reference signs, yet incremented by 200. In contrast to the device 10 shown in FIG. 1, the microwave cavity 230 of the device 210 shown in FIG. 8 has an electrically non-conductive inner surface along the inner circumference of the microwave cavity 230. Instead, the article 290 comprises an electrically conductive shell 296 (indicated by dotted line) in the substrate portion 297 which is arranged circumferentially around the aerosol-forming substrate 292, but not at the axial ends of the substrate portion 297. In the present embodiment, the electrically conductive shell 296 is metallic wrapper wrapped around the aerosol-forming substrate 292. That is, in the present embodiment, the waveguide structure is provided by the electrically conductive shell 296 rather than the inner surface along the inner circumference of the microwave cavity 230. Yet, the inner surface of the microwave cavity 230 at the closed distal end 236 preferably is electrically conductive to support microwave reflection in the proximal direction. In principle, it is also possible that the inner surface of the microwave cavity 230 along the inner circumference of the microwave cavity 230 is still electrically non-conductive, while having an electrically conductive a circumferential shell 296 around the aerosol-forming substrate 292. Instead of an electrically conductive outer shell surrounding the aerosol-forming substrate 292 only along the circumference of the article 290, the article may comprise an electrically conductive outer shell which is arranged circumferentially around the aerosol-forming substrate 292, and at both axial ends of the substrate portion 297, that is, which fully encapsulates the aerosol-forming substrate 292 in the substrate portion 297. In this case, the entire inner surface of the microwave cavity 230 may be electrically non-conductive. Yet, the coaxial feed exciter should be arranged and configured to feed the microwave signal into interior of that fully encapsulating outer shell when the article is received in the microwave cavity.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1-15. (canceled)

16. An aerosol-generating device for generating an aerosol by microwave heating of an aerosol-forming substrate contained in a substrate portion of a cylindrical aerosol-generating article, the aerosol-generating device comprising:
a microwave generator configured to generate a microwave signal;
a cylindrical microwave cavity configured to removably receive at least the substrate portion of the cylindrical aerosol-generating article; and
a coaxial feed exciter operatively connected to the microwave generator and coupled to the cylindrical microwave cavity such as to feed the microwave signal into the cylindrical microwave cavity and excite at least one specific transverse magnetic mode or transverse electric mode within the cylindrical microwave cavity when the substrate portion of the cylindrical aerosol-generating article is received in the cylindrical microwave cavity.

17. The aerosol-generating device according to claim 16, wherein the cylindrical microwave cavity is a circular-cylindrical microwave cavity or a rectangular-cylindrical microwave cavity.

18. The aerosol-generating device according to claim 16,
wherein the cylindrical microwave cavity is a circular-cylindrical microwave cavity, and
wherein the microwave generator is further configured to generate the microwave signal having a frequency below a frequency threshold f_thresh given by the following equation: f_thresh=(2.405*c)/(π*D), wherein D is the inner diameter of the circular-cylindrical microwave cavity and c is the speed of light in vacuum.

19. The aerosol-generating device according to claim 16,
wherein the cylindrical microwave cavity is a circular-cylindrical microwave cavity, and
wherein the microwave generator is further configured to generate a microwave signal having a frequency above a cutoff frequency, the cutoff frequency having a value out of a range defined by the following equation: f_cutoff=(2.405*c)/(π*D*Sqrt(ε_r)), wherein D is the inner diameter of the circular-cylindrical microwave cavity, c is the speed of light in vacuum, and ε_r is a value in a range between 2 and 2.5.

20. The aerosol-generating device according to claim 16, wherein the microwave generator is further configured to generate a microwave signal in a frequency range between 5 GHz and 50 GHz.

21. The aerosol-generating device according to claim 16,
wherein the cylindrical microwave cavity comprises an electrically nonconductive inner surface, or
wherein at least a portion of an inner surface of the cylindrical microwave cavity and an inner surface along an inner circumference of the cylindrical microwave cavity is electrically conductive.

22. The aerosol-generating device according to claim 16,
further comprising an electrically nonconductive hollow cylindrical filler arranged within the cylindrical microwave cavity,
wherein an outer circumferential surface of the hollow cylindrical filler is in contact with an inner surface of the cylindrical microwave cavity along an inner circumference of the cylindrical microwave cavity, and
wherein an inner void of the hollow cylindrical filler provides a receiving chamber configured to removably receive at least the substrate portion of the cylindrical aerosol-generating article.

23. The aerosol-generating device according to claim 16,
wherein the coaxial feed exciter comprises a coaxial line having an inner conductor surrounded by a concentric outer conductor shield, and
wherein a cavity-side end portion of the inner conductor extends beyond a cavity-side end of the outer conductor shield into the cylindrical microwave cavity to form an excitation probe.

24. The aerosol-generating device according to claim 23,
wherein a length of the excitation probe extending beyond the cavity-side end of the outer conductor shield into the cylindrical microwave cavity is in a range between 1 millimeter and 8 millimeters, and/or
wherein a diameter of the excitation probe is in a range between 1 millimeter and 2 millimeters.

25. The aerosol-generating device according to claim 16,
wherein the cylindrical microwave cavity is a circular-cylindrical microwave cavity, and
wherein a diameter of the circular-cylindrical microwave cavity is in a range between 2 millimeters and 15 millimeters.

26. An aerosol-generating system comprising an aerosol-generating device according to claim 16 and a cylindrical aerosol-generating article comprising a distal substrate portion containing an aerosol-forming substrate.

27. The aerosol-generating system according to claim 26,
wherein the cylindrical aerosol-generating article further comprises a proximal portion proximally adjacent to the distal portion, and
wherein a material of the proximal portion axially facing the distal substrate portion has a static relative dielectric permittivity lower than a static relative dielectric permittivity of the aerosol-forming substrate contained in the distal substrate portion.

28. The aerosol-generating system according to claim 27, wherein the material of the proximal portion axially facing the distal substrate portion has a static relative dielectric permittivity in a range between 1 and 1.5.

29. The aerosol-generating system according to claim 26, wherein the aerosol-forming substrate has a static relative dielectric permittivity in a range between 2 and 2.5.

30. The aerosol-generating system according to claim 26, wherein the microwave generator is further configured to generate a microwave signal having a frequency above a cutoff frequency f_cutoff given by the following equation: f_cutoff=(2.405*c)/(π*D*Sqrt(ε_r)), wherein D is the inner diameter of the cylindrical microwave cavity, c is the speed of light in vacuum, and ε_r is the static relative dielectric permittivity of the aerosol-forming substrate.
